(19) United States
(12) Patent Application Publication
(10) Pub. No.: US 2022/0260850 A1
(43) Pub. Date: Aug. 18, 2022

(54) Basic Display for an Autostereoscopic Display Arrangement

(71) Applicant: SeeFront GmbH, Hamburg (DE)

(72) Inventors: Christoph Grossmann, Hamburg (DE); Peer Stelldinger, Hamburg (DE)

(21) Appl. No.: 17/623,035

(22) PCT Filed: Jun. 8, 2020
(86) PCT No.: PCT/EP2020/065834

§ 371 Date: Dec. 27, 2021

(30) Foreign Application Priority Data
Jul. 17, 2019 (EP) 19186719.1

(51) Int. Cl. G02B 30/30

(52) U.S. Cl. CPC G02B 30/30

(57) ABSTRACT

A basic display (10) for an autostereoscopic display arrangement (30, 32) having pixels (12) arranged in a periodic raster, in which at least one of the two diagonals (f1, f2) that form an angle of 45° with the display horizontal (x) has the property that, for two arbitrary pixels (12) that fulfill the condition that a straight line (g) passing through the center points (P) of the two pixels forms an angle of between −2° and 2° with the diagonal (f1, f2), the center distance (d1, d2) of the pixels is greater than 1.5 times, preferably greater than 1.8 times, more preferably greater than twice a basic distance (e) that is defined as the minimum of the center distances of all pixel pairs.

The invention relates to a basic display for an autostereoscopic display arrangement having pixels arranged in a periodic raster.

The basic display may for example be a computer screen or the screen of a tablet or smartphone. In order to form an autostereoscopic display arrangement, starting from the basic display, a so-called parallax barrier is superposed on the basic display with a certain spacing, the parallax barrier being arranged such that light rays that propagate from the surface of the screen towards a viewer are shielded or deflected such that some of the pixels of the screen are visible only with the left eye whereas another set of the pixels is visible only with the right eye. The pixels that are visible for the left and right eyes constitute an alternating sequence of stripes. When an object is to be displayed autostereoscopically, the pixels in the respective stripes are controlled such that the left and right eyes of the viewer see the object with a parallactic displacement that corresponds to the three-dimensional geometry of the object. An example of an autostereoscopic display device of this type has been described in WO 2016/107892 A1.

The parallax barrier may be constituted for example by a stripe barrier which obscures certain stripe-shaped zones on the surface of the basic display for one eye of the viewer, or by a lenticular lens raster formed for example by parallel cylindric lenses which magnify the pixels in the visible stripes on the screen surface like a magnifying glass whereas the light from other pixels is so deflected that it does not reach the corresponding eye of the viewer.

In order to be able to render also three-dimensional images with a resolution as high as possible, the period of the stripes created by the parallax barrier should not be substantially larger than the period of the pixels in the pixel raster.

However, the superposition of two periodic structures with similar periods, i.e. the pixel raster and the parallax barrier, may cause disturbing artefacts in the form of spatial beats which are also known as Moiré beat patterns. One way to suppress this beat effect is to mount the parallax barrier such that its stripes are slightly inclined relative to the vertical of the display. Since the eyes of the viewer are normally aligned on a horizontal line, it is preferred to use an inclination of the parallax barrier in which the angle formed between the horizontal x of the display and the stripes of the parallax barrier amounts to at least 55°. The display horizontal x is defined here as the direction which is obtained as the straight intersection line between the plane of the display and a second plane which is characterized in that it contains the center points of both eyes of the viewer when the head of the viewer is not tilted. Thus, in a typical rectangular display, the display horizontal x is generally parallel to the upper and lower edges of the display. The display vertical y extends in the plane of the display and is orthogonal to the display horizontal, so that it is typically parallel to the left and right edges of the display. If a display is rotated by 90°, the former display horizontal becomes the new display vertical, and the former display vertical becomes the new display horizontal.

A tablet or smartphone can typically be used in both, the portrait format and the landscape format by rotating it by an angle of 90°. A user will expect this property also in the 3D-mode. However, the parallax barriers that have commonly been used up to now and in which the stripes extend almost vertically, are suitable only for either displaying images in the landscape format or displaying the images in the portrait format.

US 2012/050857 A1 describes an autostereoscopic display device that utilizes two switchable parallax barriers, so that changing the format from portrait to landscape includes switching to another parallax barrier. U.S. Pat. No. 8,441,584 B2 discloses a stripe barrier constituted by a liquid crystal display (LCD) with which different stripe pattern can be generated by suitably controlling the LCD.

It is an object of the invention to provide a basic display which can easily be turned into an autostereoscopic display arrangement that enables watching images in both, portrait format and landscape format without changing the parallax barrier, by having the stripes of the parallax barrier extend under an approximately diagonal angle relative to the display horizontal x.

According to the invention, this object is achieved by the feature that at least one of the two diagonals that form an angle of 45° with the display horizontal x has the property that, for two arbitrary pixels that fulfill the condition that a straight line passing through the center points of the two pixels forms an angle of between −2° and 2° with the diagonal, the center distance of the pixels is greater than 1.5 times, preferably greater than 1.8 times, more preferably greater than twice a basic distance that is defined as the minimum of the center distances of all pixel pairs.

In a typical display with a square pixel raster aligned with the display horizontal x and the display vertical y, all pairs of directly adjacent pixels have a uniform center distance which then constitutes the basic distance by definition. Then, for relatively closely neighbouring pixels that are aligned exactly or at least approximately on a diagonal of the pixel raster, the center distance amounts to about 1.414 times the basic distance (square root of 2). According to the invention, such a pixel raster is turned into a modified pixel raster in which the center distance for the pixels that are essentially aligned on a diagonal (designated as diagonal distance hereinafter) is enlarged to at least 1.5 times the basic distance, preferably at least twice the basic distance.

This particular property of the pixel raster has the advantage that, in order to form an autostereoscopic display arrangement, it is possible to use a parallax barrier in which the stripes extend “diagonally”, i.e. form an angle of approximately 45° with the display horizontal x, without producing disturbing beat effects. In this way, it is possible to use one and the same parallax barrier for displaying images in both, portrait format and landscape format. The suppression of the beat effects is essentially due to the fact that, in the direction of the diagonal that extends in parallel with the stripes of the parallax barrier, the pixel raster has a period that is so dimensioned that the spatial frequency of the beats is increased to such an extent that it approaches the limit of the resolution of the pixel raster and is therefore no longer perceptible.

The invention also relates to an autostereoscopic display arrangement having a basic display with the property described above. In this arrangement, the stripes of the parallax barrier extend approximately in a diagonal direction, i.e. the angle between these stripes and the display horizontal x is between 40 and 50°. If the pixel raster is configured such that the condition “center distance of pixels along the same diagonal is larger than 1.5 times, preferably larger than twice the basic distance” is fulfilled also for pairs of pixels for which the direction of the straight line connecting the center points deviates slightly from the 45° direction, e.g. by ±2°, preferably ±5°, then the direction of the stripes of the parallax area may also deviate from the diagonal by a certain angle.

Useful details and further developments of the invention are indicated in the dependent claims.

The property of the pixel raster that has been described above can be obtained for example by a process in which, starting from one of the standard pixel rasters that are commonly used today, such as “Standard-RGB-Stripe”, “PenTile Diamond” or the like, the raster is contracted or expanded by a certain factor in one direction, e.g. the direction normal to the display horizontal x. Another possibility is to shift the pixels in successive lines or columns of the pixel raster relative to one another by a fraction of the pixel width or the pixel height, respectively.

Embodiment examples will now be described in conjunction with the drawings, wherein:

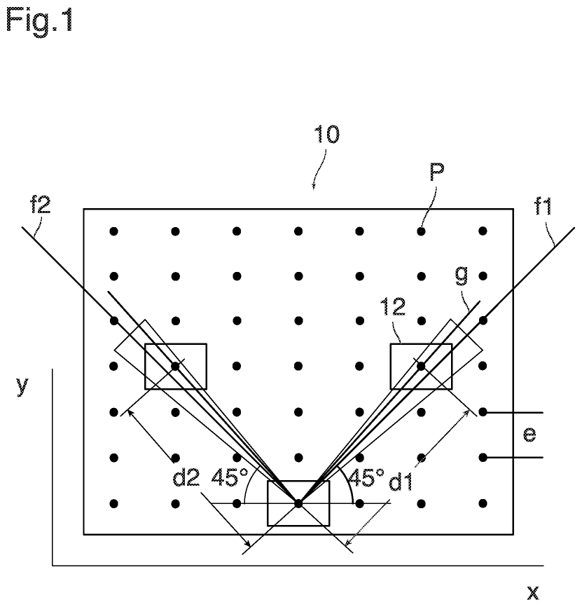

FIG. 1 is an enlarged clipping of a basic display in according to the invention;

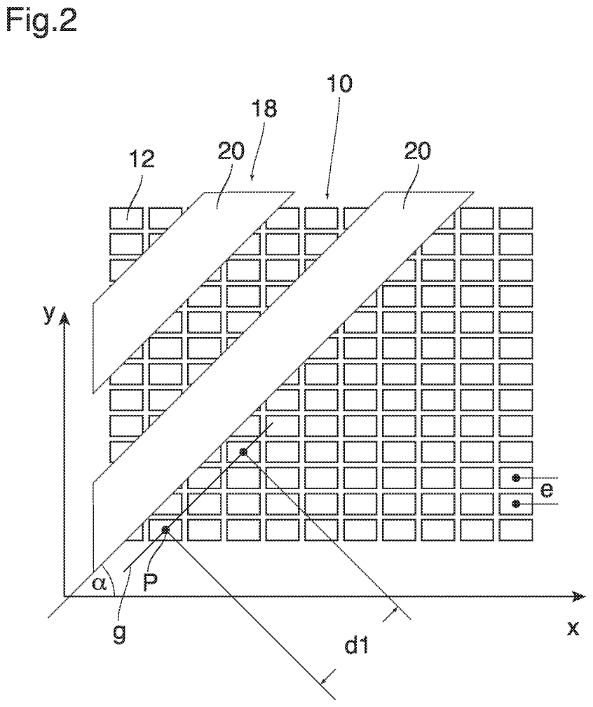

FIG. 2 is an enlarged clipping of an autostereoscopic display arrangement having a basic display according to the invention;

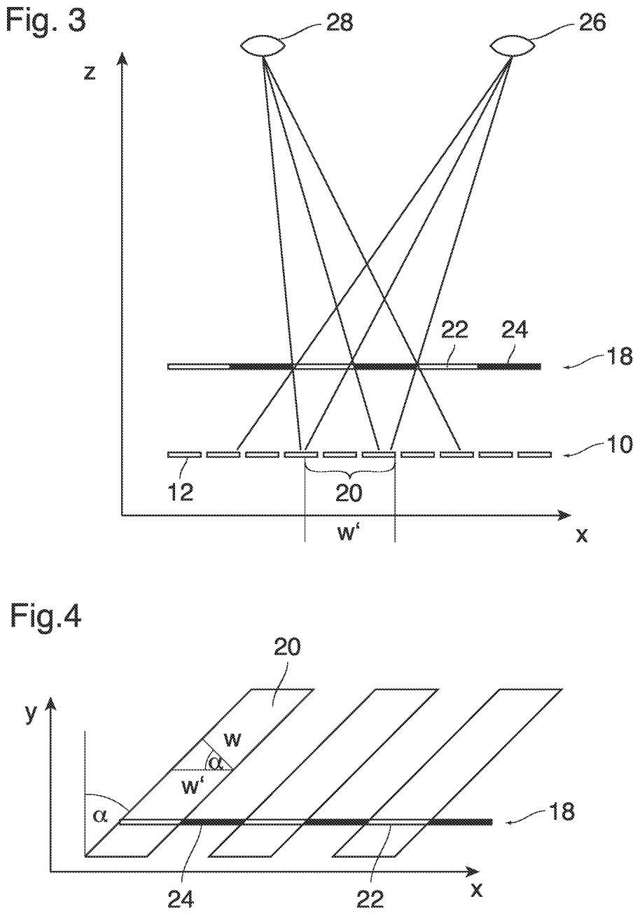

FIG. 3 is a sketch for explaining the principle of an autostereoscopic display;

FIG. 4 is a sketch of a parallax barrier;

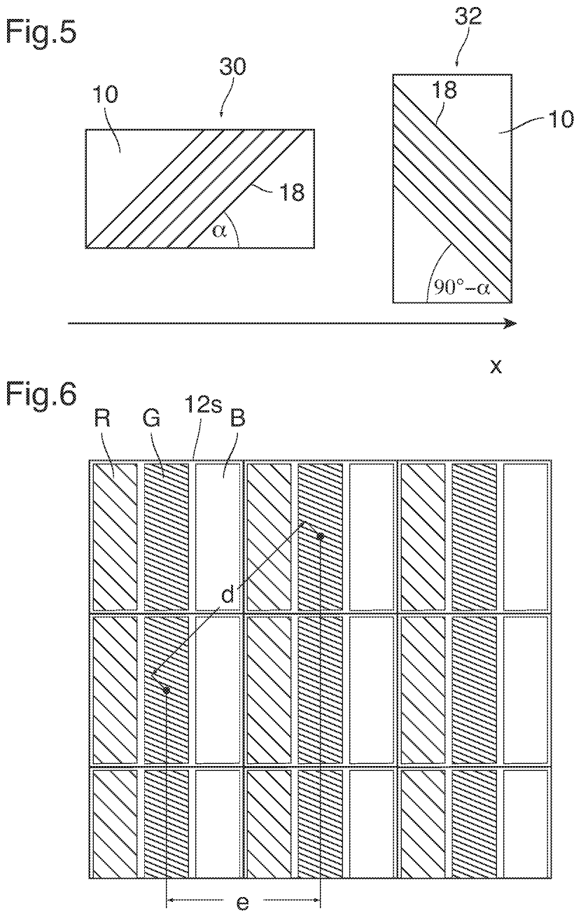

FIG. 5 shows illustrations of an autostereoscopic display device in landscape format and portrait format;

FIG. 6 is an enlarged clipping of a pixel raster of a conventional Standard-RGB-Stripe basic display;

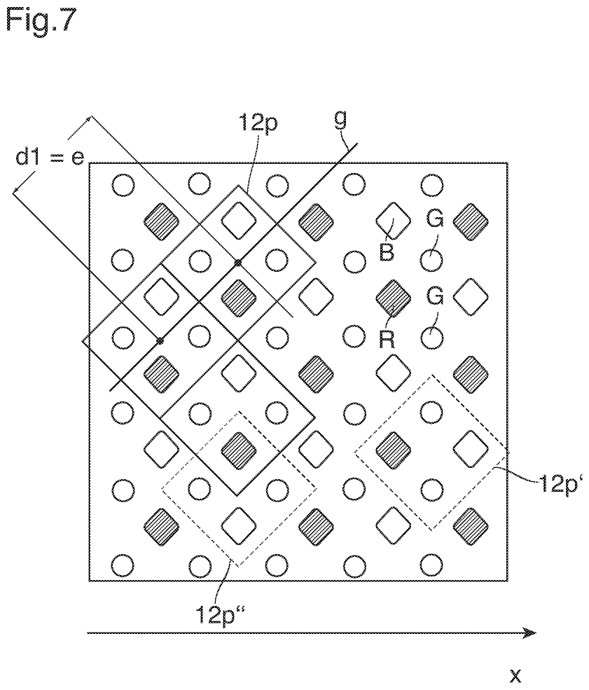

FIG. 7 is an enlarged clipping of a pixel raster of a conventional PenTile Diamond basic display;

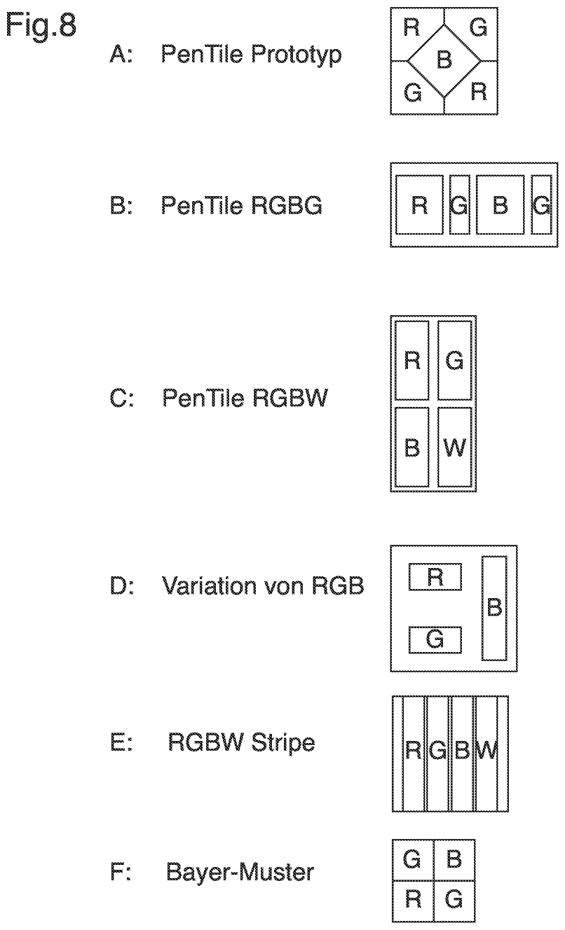

FIG. 8 shows pixel structures of several known standard pixel rasters;

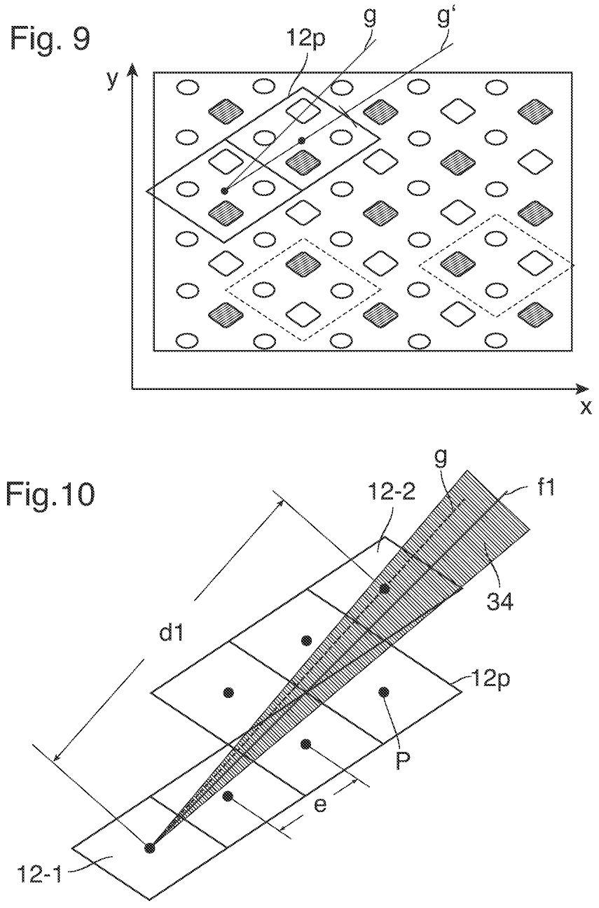

FIG. 9 shows a pixel raster of a basic display according to the invention that has been obtained by modifying the pixel raster shown in FIG. 7;

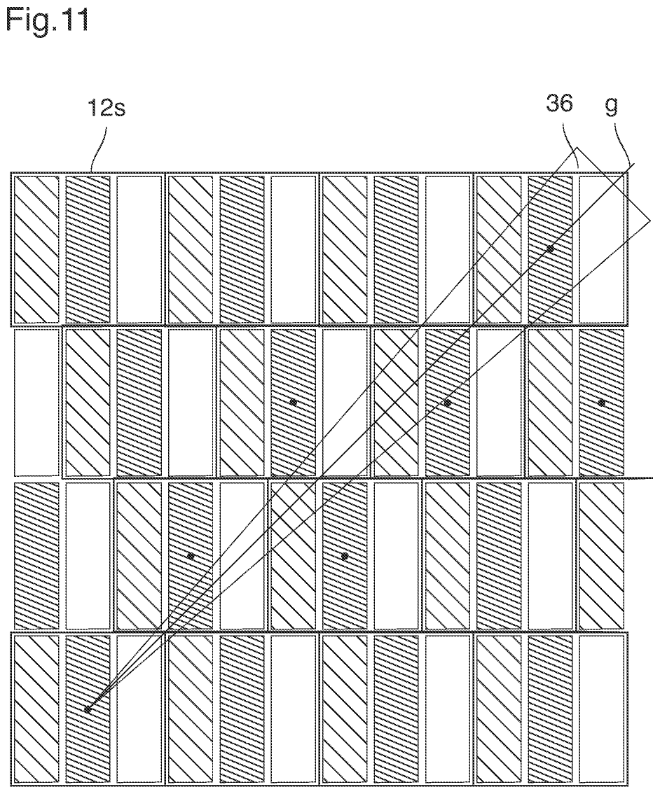

FIG. 10 is a sketch for explaining a property of the pixel raster according to FIG. 9;

FIG. 11 shows a pixel raster of a basic display according to another embodiment, obtained by modification of the pixel raster shown in FIG. 6;

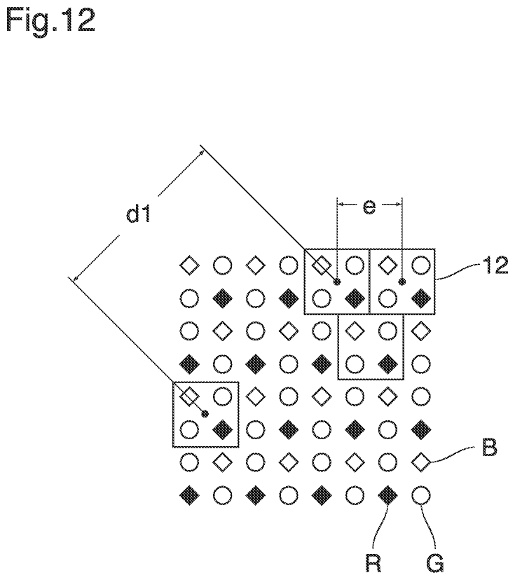

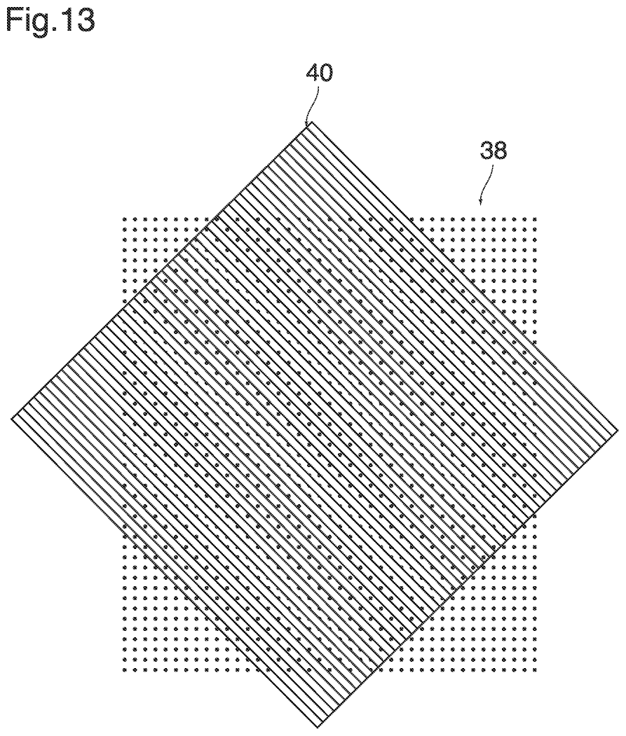

FIG. 12 shows a pixel raster of a basic display according to yet another embodiment of the invention, obtained by modification of another basic raster;

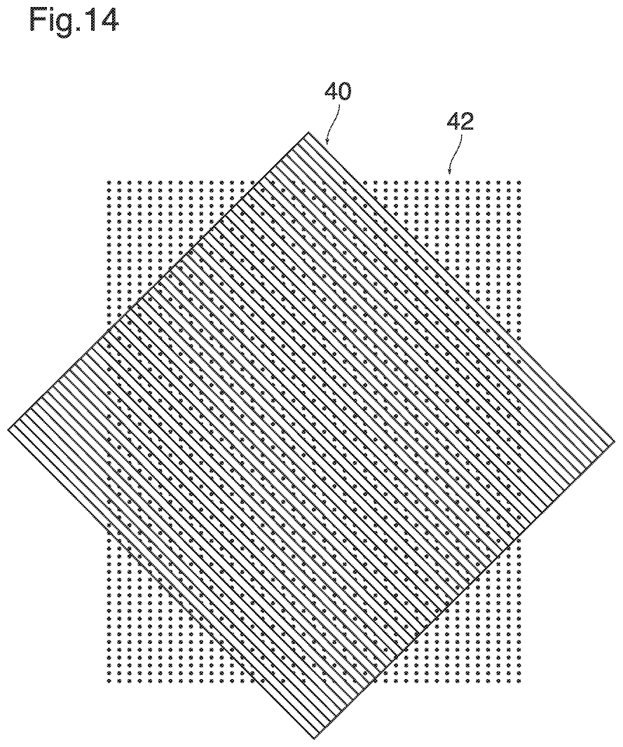

FIG. 13 is a simulation of a conventional autostereoscopic display device having a 45° parallax barrier; and

FIG. 14 is a simulation of a display device according to the invention.

FIG. 1 shows a clipping of a display surface of a basic display 10, e.g. a display of a tablet computer or smartphone, that forms part of an autostereoscopic display device according to the invention. The basic display 10 has pixels 12 which can be controlled individually and are arranged in a periodic raster which has been represented in FIG. 1 by showing the positions of the center points P of the pixels.

A unit of length that is characteristic for the pixel raster, the so called basic unit e is defined as the minimum of the center distances of all pairs of pixels 12. In the example shown, e corresponds to the distance between the center points of two vertically adjacent pixels, i.e. it corresponds exactly to the pixel height. In general, however, the basic unit e does not have to correspond to the center distance between two pixels that are adjacent to one another in strictly vertical or strictly horizontal direction, but it can also correspond to the center distance between obliquely adjacent pixels, if this distance is minimal in comparison to all other center distances.

In FIG. 1, a display horizontal has been designated as x, and the display vertical has been designated as y. Typically, the display horizontal x extends in parallel with the lower edge of the display and the display vertical y extends in parallel with the lateral edges of the display. Two diagonals that are defined by the property that they form an angle of 45° with a display horizontal, have been designated as f1 and f2. Further, in FIG. 1, a straight line g that extends in approximately diagonal direction has been positioned such that it passes through the center points P of two pixels. The center distance d1 between these two pixels amounts to about 4.2 times the basic unit e.

In the entire pixel raster shown in FIG. 1, there is no pair of two pixels 12 for which the center points P are aligned on a straight line parallel to f1 and for which the center distance is smaller than d1. Also for pixel pairs for which the interconnecting straight line is not exactly parallel with f1 but deviates from f1 by an angle of ±2° or even ±5°, the center distance is not smaller than d1. Analogously, there is a minimum center distance d2 of the center points of pixels for which the interconnecting straight line extends approximately parallel to f2. The term “diagonal distance” d1 and d2, respectively, with respect to the diagonal f1 and f2, respectively, shall therefore generally designate the smallest center distance of two pixels 12 for which the straight line passing through the center points P is in the angular range of ±2°, preferably ±5° about the diagonal f1 and f2, respectively.

FIG. 2 shows an autostereoscopic display device that is based on the basic display 10 shown in FIG. 1. Superposed to the basic display 10 is a parallax barrier 18 which is here represented by only two stripes 20 of a sequence of stripes. For a given position of an eye of a viewer, e.g. the left eye, the stripes 20 designate the zones on the basic display 10 the pixels of which are not visible due to the parallax barrier 18. The gaps between the stripes 20 designate the zones in which the pixel 12 are visible for the left eye of the viewer. Conversely, for the right eye, the pixels under the stripes 20 would be visible and the pixels in the gaps would be invisible.

In the example shown in FIG. 2, the parallel stripes 20 form an angle α of 45° with the display horizontal x.

Thanks to the large diagonal distance in the pixel raster shown here, the superposition of the parallax barrier 18 on the periodic pixel raster does not lead to disturbing beat effects. The same holds true also when the angle between the stripes 20 of the parallax barrier 18 and the display horizontal x is not exactly 45° but deviates therefrom by up to ±5°. This creates a certain tolerance range which permits to optimize the suppression of beat effects by fine-tuning the angle α.

The function principle of the autostereoscopic display shall briefly be explained in conjunction with FIG. 3. A basic display 10 having the pixels 12 has been shown in a side view in FIG. 3. The parallax barrier 18, in this case a stripe barrier having an alternating sequence of transparent stripes 22 and intransparent stripes 24 has been arranged above the basic display 10 with a certain spacing (in the direction z). Together, the basic display 10 and the parallax barrier 18 form the autostereoscopic display device. Also shown are the left and right eyes 26, 28 of a viewer who watches the display device from a certain viewing distance. For the left eye 26 of the viewer, the intransparent stripes 24 define the positions of the stripes 20 with invisible pixels on the basic display 10, and the transparent stripes 22 of the parallax barrier define the gaps between these stripes 20. For the right eye 28 of the viewer, those pixels are visible that are invisible for the left eye 26 and vice versa. A three-dimensional image perception can be achieved if, dependent upon the viewing distance and the distance between the eyes of the viewer, the pixels 12 are controlled such that the left eye 26 receives only the image information for the left eye and the right eye 28 receives only the image information for the right eye. For pixels on the boundary between the intransparent and the transparent stripes, it is convenient to control the individual sub-pixel separately in accordance with their position relative to this boundary.

In order to achieve a spatial resolution as high as possible in the three-dimensional display of images (in the 3D-mode) the period length of the parallax barrier should be chosen to be as small as possible. Preferably, however, it should be so large that more than a half of a pixel 12 is visible in the respective gaps between the stripes 20. Pursuant to the intercept theorem, the width of the transparent stripes 22 and the intransparent stripes 24 (or, if the parallax barrier is a lenticular raster, the width of the cylindrical lenses) depends upon the viewing distance, the distance between the eyes 26, 28 and the (effective) distance between the basic display 10 and the parallax barrier 18. In order to obtain a display device as compact as possible, with a small spacing between the basic display 10 and the parallax barrier 18, the width of the stripes 20, 22 should be selected to be small.

As has been shown in FIG. 4, the inclination of the parallax barrier 18 relative to the display horizontal x, more specifically, the angle α between the strips 20 and the direction x, is also relevant. The plane of the image in FIG. 4 is the plane that is spanned by the axes x and y, so that the viewing direction extends vertically onto the stripes 20. Only the parallax barrier 18 that eventually generates the strips 20 has been shown in cross-section as in FIG. 3. The difference between the width of the stripes 22, 24 on the one hand and the width of the stripes 20 on the other hand can be neglected in this analysis. The apparent width of the stripes in the direction x has been designated as w′ in FIGS. 3 and 4. In FIG. 4, the true width w of the stripes in the direction normal to the direction of the stripes has also been shown. They fulfil the relation

w=w′*cos(α).

It is advantageous if (as in FIG. 2) the angle α is at least approximately 45°. In this case, the display device can be used for displaying images in both, landscape format and portrait format, as has been illustrated in FIG. 5. There, two autostereoscopic display arrangements 30, 32, each of which comprises the basic display 10 and a parallax barrier 18 which is only symbolized by a number of parallel stripes, have been shown schematically. The display arrangement 30 is oriented such that images (also in 3D) are displayed in landscape format. The lower edge of the display extends in the direction x. The display arrangement 32 is oriented such that images are displayed in portrait format. The lower edge of the display, which extends in the direction x, is then the shorter edge of the basic display. The spatial relation between the basic display 10 and the parallax barrier 18 is the same in both display arrangements 30, 32, and in both cases the parallax barrier forms an angle α of (approximately) 45° with the display horizontal x.

FIG. 6 shows a clipping of a conventional pixel raster for a color display. This pixel raster that is known under the designation “standard RGB-Stripe” has square pixels 12s. FIG. 6 shows 3×3 of these pixels. Each pixel 12s is divided into three stripe-shaped sup-pixel R, G, B, corresponding to the basic colours red, green and blue, being arranged side by side. The pixel width is equal to the pixel height and equal to the basic unit e. The diagonal distance d1 and d2, respectively, i.e. the center distance between two adjacent pixels on a diagonal, is approximately 1.414 e for both diagonals. Thus, this conventional pixel raster does not have the property that has been described for the pixel raster according to the invention in conjunction with FIG. 1.

Another example of a known pixel raster of a color display has been shown in FIG. 7. This pixel raster is designated as “PenTile Diamond”. The individual pixels that are designated here as 12p have a “diamond shape” (square with the edge length e, rotated by) 45°. Each pixel 12p includes a sub-pixel R, a sub-pixel B and two somewhat smaller sub-pixels G. Here, the diagonal distances d1 and d2 are exactly 1 e for both diagonals f1 and f2.

A set of sub-pixels in different colors which, together, constitute a pixel, shall more generally be designated as the set (of sub-pixels) of this pixel hereinafter. Thus, the set of a pixel in the PenTile Diamond configuration comprises four sub-pixels, as described above. It can also been written as RGBG.

In the pixel raster “PenTile Diamond” as shown in FIG. 7, there are, (as in most other pixel rasters, several possibilities to define pixels such that each pixel comprises exactly one sub-pixel B, one sub-pixel R and two sub-pixels G. Two examples for alternative possibilities have been shown in phantom lines and designated as 12p′ and 12p″ in FIG. 7. Because of this ambiguity, which exists also for some other pixel rasters, it should be defined more precisely what is meant by a “pixel” in this specification.

For the purpose of this specification, a “pixel” is defined as a coherent sub-surface T of the surface of the basic display which fulfils the following conditions:

(1) T contains exactly one set of sub-pixels.

(2) The plane of the display can be composed (tessellated) completely and without overlap with a plurality of surfaces that result from a translation of T.

Some other common pixel rasters for colour displays have been listed below, and the diagonal distances d1 and d2 have been indicated for each pixel raster. In all these cases, the diagonal distance is the same for both diagonals, d1=d2. The pixel configurations of these standard pixel raster are shown in FIGS. 8A-F. What has been shown there is respectively the contour of a single pixel as well as the arrangement of the sub-pixels R, G, B, W (W stands for “white”) within the pixel.

d1=d2=˜1.414e PenTile Prototyp:

d1=d2=1e PenTile RGBG:

d1=d2=1e PenTile RGBW:

d1=d2=˜1.414e Variation of RGB:

d1=d2=˜1.414e RGBW Stripe:

d1=d2=˜1.414e. Bayer Muster

Thus, it turns out that for all these common pixel rasters and independently of the diagonal that has been selected, the diagonal distance in basic units is not larger than about 1.414.

Now, with reference to FIG. 9, an example shall be given, how a conventional pixel raster can be modified in such a way that it fulfils the condition:

d1>1.5e or d2>1.5e diagonal distance

for at least one of the diagonals f1 and f2.

In FIG. 9, the pixel raster shown in FIG. 7 has been modified by contracting the entire raster by the factor ⅔ in the direction y. The center points of the pixels 12p have been shifted relative to one another by this contraction such that the center points that were located on a 45° straight line g in FIG. 7 are now located on a straight line g′ that deviates from the line g by an angle of more than 3° (in this specific example more than 8°), so that the center distance of these two pixels is no longer a “diagonal distance” in the meaning of the definition given above. The basic distance e still corresponds to the distance between the two pixels 12p that are connected by the line g′.

FIG. 10 shows some pixels 12p of the contracted pixel raster shown in FIG. 9. The respective center points P have also been shown, just as the diagonal f1 and an angular range 34 of +/−5° around the diagonal f1. If one starts from the pixel 12-1 bottom left in FIG. 9, it can be seen that the next pixel 12-2 the center point of which is again within this angular range 34 can be found only in the third-next pixel column. This corresponds to a diagonal distance d1 of about 3.73 e. However, this pixel is outside of the angular range of +/−2° around the diagonal f1, so that the diagonal distance d1 for this angular (range is approximately 4.71.

Analogously, other known pixel rasters can also be contracted in order to raise the diagonal distance for at least one of the two diagonals f1, f2 to at least 1.5 e or preferably at least 2 e.

If the pixel raster is modified by contraction, other contraction factors than ⅔ are also possible. For example, a contraction factor ½ is also attractive. If, for example, the standard-RGB-Stripe raster or the PenTile Diamond raster is contracted by the factor ½, one obtains the diagonal distance d1=d2=˜2.828 e irrespective of the choice of the diagonal f1, f2. Moreover, the loss in perceived resolution in the 3D mode, which is due to the fact that the number of sub-pixels has doubled in comparison to the non-contracted PenTile Diamond raster, is largely compensated.

If a contraction with the contraction factor ½ is applied to the standard-RGB-Stripe raster, there is also the attractive possibility to control, in the 2D mode, two superposed (contracted) pixels with the same signal so as to unite them to a single (square) pixel. Then, in the 2D mode, the display is compatible with image files for which the same resolution is provided in line direction and column direction. Alternatively, it is of course also possible in the 2D mode to control the contracted pixels independently of one another in order to take advantage of the increased resolution in the direction y.

As an alternative to a contraction, the diagonal distance can also be varied by means of expansion, so that preferable pixel rasters may be derived from not preferable pixel rasters also in this way.

Another possibility to modify known pixel rasters comprises offsetting the pixels in successive lines by a fraction of the pixel width. This has been shown in FIG. 11 for a modification of the standard-RGB-Stripe pixel raster shown in FIG. 6. The topmost line in FIG. 11 shows the same pixels 12s as in FIG. 6. In the next line below, all pixels have been shifted to the right by the width of one sub-pixel. In the third line from above, the pixels have again been shifted by the width of one sub-pixel, and in the fourth line, after another shift by the width of one sub-pixel, one obtains again the same pixel pattern as in the topmost line. The diagonal f1 has been shown for the pixel in the bottom left corner, and an angular zone 36 of +/−2° around the diagonal f1 have also been shown. It can be seen that also in the second line from below and in the line thereabove there are no pixels the center point of which is within the angular zone 36. Such a pixel, that is located in this zone, is only found again in the topmost line (in the top right corner). Again, the diagonal distance d1, d2=˜4.2 e for both diagonals. If the raster is modified by shifting, it is not always the case that the diagonal distances d1, d2 for both diagonals f1, f2 are equal. For example, if, in this pixel raster, the admissible angular range of the angular zone 36 is increased from +/−2° to +/−5° around the diagonal f1, then one obtains a diagonal distance d1 of approximately 1.1 e for the diagonal f1 and a diagonal distance d2 of approximately 2.6 e for the diagonal f2.

Analogously, the pixel raster could also be modified by shifting by the width of one sub-pixel to the left.

This kind of modifying the raster by shifting the lines is also applicable for other pixel rasters. Analogously, advantageous rasters may also be obtained by means of a vertical shift of columns.

When the pixel raster is modified by line shift, the offset does not have to have the same amount in each line. For example, it is also possible to shift only every second line.

Likewise is it possible to shift the lines alternatingly to the right and to the left. In this modification of a standard-RGB-Stripe raster one obtains a diagonal distance of about 2.828 e for each diagonal.

In case of a “Bayer-Muster”, a shift by a half pixel width leads also to a diagonal distance of about 2.828 e, as has been shown in FIG. 12. Here, the sub-pixels R, G, B of each pixel 12 have been made distinguishable by using different shapes and filling colours. The pixels in the successive lines are respectively shifted relative to one another by e/2. The center distance d2 has been shown for two pixels 12 on a common diagonal f1. This center distance is not underscored for any pair of pixels on the same diagonal.

For modifying a standard pixel raster, it is also conceivable to combine the two methods described above. For example, if the standard-RGB-Stripe raster is contracted by the factor ⅓ and, further, the lines are shifted relative to one another by ⅓ pixel width, one obtains the advantageous diagonal distance d1=˜4.242 e for one of the two diagonals, whereas a diagonal distance of only d2=1 e is obtained for the other diagonal.

It is a particular advantage of the example shown in FIG. 11, that groups of three different sub-pixels are respectively found again in the original pixel positions. Therefore, in these original pixel positions, the same colour value can be generated as in a normal RGB pixel, with the only difference that the positions of the sub-pixels are exchanged cyclically. This, however, is not relevant for the display of images in the 2D mode. Thus, if no autostereoscopic display is desired, the display can be controlled in the 2D mode in the like manner as the standard-RGB-Stripe display. This advantage can also be achieved by means of the modifications of some other standard pixel rasters, e. g. by the modified Bayer-Muster with a pixel offset of a half pixel width that has been mentioned above (see FIG. 12).

The effect of the modifications of the pixel raster that have been proposed here shall be illustrated in FIGS. 13 and 14.

FIG. 13 shows a conventional square pixel raster 38 in combination with a parallax barrier 40 that is inclined at an angle of 45°. One perceives a significant beat pattern with a period that is approximately eight times the period of the parallax barrier 40, so that the variations in brightness are clearly visible. FIG. 14 shows the same parallax barrier 40 in combination with a contracted pixel raster according to the invention. Here, no beat effect can be perceived. Of course, the period of the beat pattern in FIG. 13 depends also upon the width of the parallax barrier. The effect shown in FIG. 14, i.e. the suppression of beats, is found however for parallax barriers with all commonly used widths.

What is claimed is:

1. A basic display for an autostereoscopic display arrangement having pixels arranged in a periodic raster, comprised by:
at least one of two diagonals that form an angle of 45° with a display horizontal has the property that, for two arbitrary pixels that fulfill the condition that a straight line passing through center points of the two pixels forms an angle of between −2° and 2° with the one diagonal, a center distance of the pixels is greater than 1.5 times a basic distance that is defined as a minimum of the center distances of all pixel pairs.

2. The basic display according to claim 1,
wherein the pixel raster is derived from one of the following standard pixel rasters: Standard-RGB-Stripe, PenTile-Prototyp, PenTile RGBG, PenTile RGBW, PenTile Diamond, Variation of RGB, RGBW Stripe, and Bayer-Muster, and
wherein the pixel raster is derived from the standard pixel raster by one or more of the following:
expansion or contraction normal to or along the direction of the display horizontal,
a shift of individual lines relative to one another by less than one pixel width and
a shift of individual columns relative to one another by less than one pixel height.

3. The basic display according to claim 2, wherein the pixel raster is contracted by a factor ⅔.

4. The basic display according to claim 2, wherein the pixel raster is contracted by a factor ½.

5. The basic display according to claim 3, wherein the standard pixel raster is Standard-RGB-Stripe.

6. The basic display according to claim 3, wherein the standard pixel raster is PenTile Diamond.

7. The basic display according to claim 1, wherein at least one of the two diagonals that form an angle of 45° with the display horizontal has the property that, for two arbitrary pixels that fulfill the condition that a straight line passing through the center points of the two pixels forms an angle of between −5° and 5° with the diagonal, the center distance of the pixels is greater than 1.5 times the basic distance.

8. An Autostereoscopic display arrangement comprising a basic display according to claim 1, and a parallax barrier that forms an angle between −5° and 5° with one of the diagonals, wherein the center distance of the pixels on the straight line is larger than 1.5 times the basic distance.

9. The basic display according to claim 1, wherein the center distance of the pixels is greater than 1.8 times the basic distance.

10. The basic display according to claim 1, wherein the center distance of the pixels is greater than twice the basic distance.

11. The basic display according to claim 4, wherein the standard pixel raster is Standard-RGB-Stripe.

12. The basic display according to claim 4, wherein the standard pixel raster is PenTile Diamond.

13. The basic display according to claim 7, wherein the center distance of the pixels is greater than 1.8 times the basic distance.

14. The basic display according to claim 7, wherein the center distance of the pixels is greater than twice the basic distance.

15. The Autostereoscopic display arrangement according to claim 8, wherein the center distance of the pixels is greater than 1.8 times the basic distance.

16. The Autostereoscopic display arrangement according to claim 8, wherein the center distance of the pixels is greater than twice the basic distance.
